(19) United States
(12) Patent Application Publication
(10) Pub. No.: US 2025/0027821 A1
(43) Pub. Date: Jan. 23, 2025

(54) HIGH TEMPERATURE OPERATING ELECTRONIC CIRCUIT FOR PRESSURE OR TEMPERATURE SENSOR

(71) Applicant: HYDRA-ELECTRIC COMPANY, Burbank, CA (US)

(72) Inventor: Robert Andrew Guziak, West Mifflin, PA (US)

(21) Appl. No.: 18/714,008

(22) PCT Filed: Nov. 22, 2022
(86) PCT No.: PCT/US2022/050774

§ 371 Date: May 28, 2024

Related U.S. Application Data
(60) Provisional application No. 63/283,637, filed on Nov. 29, 2021.

(51) Int. Cl. G01K 7/16; G01K 15/00; G01L 1/22

(52) U.S. Cl. CPC G01K 7/16; G01L 1/2268; G01K 15/005

(57) ABSTRACT

Systems, devices, and methods for attenuating upset signals from measurement signals in high-temperature environments including an upset event detector configured to determine if an upset event exists in a measurement signal; and a processor in communication with the upset event detector, where the processor is configured to: compensate the measurement signal for the upset event if the upset event is determined to exist by the upset event detector.

### CROSS-REFERENCE TO RELATED APPLICATIONS

This application is a 35 U.S.C § 371 National Stage Entry of International Application No. PCT/US2022/050774, filed Nov. 22, 2022, which claims the priority benefit of U.S. Provisional Patent Application Ser. No. 63/283,637 filed Nov. 29, 2021, the contents of all of which are hereby incorporated herein by reference in their entireties for all purposes.

### FIELD OF ENDEAVOR

The invention relates generally to high temperature sensor systems, and more particularly to high temperature sensor systems with filters for upset events.

### BACKGROUND

Sensors provide an important role in various fields by detecting important parameters. For example, processes found in aircraft, down hole drilling operations, power generation, nuclear systems and automotive all require the use of equipment where information such as pressure and temperature measurements are critical. In order to obtain accurate measurements, sensors are often subjected to harsh environmental conditions. For example, sensor systems in airplanes may have to tolerate temperatures between 200° C. to 300° C. while measuring a pressure in a hydraulic pump. A high operating temperature environment may be defined as temperatures between 150 to 300 degrees C.

Other examples of harsh environmental conditions that may coincide with high temperatures include radiation intense environments. In space applications, ionizing radiation creates an environment where ionizing particles may impact within a circuit and cause transient upsets in a measured signal. Deep space applications may experience high energy particle collisions from both ionized particle solar radiation and deep space neutron fluence. These high energy particles can induce transients to the measurements seen as fast occurring errors.

### SUMMARY

A system embodiment may include: a sensor element, where the sensor element provides a measurement signal related to a connected measurement device such as a strain gauge or thermometer; a passive compensation, where the passive compensation compensates the measurement signal for non-radiation errors, generates a filter based on a bandwidth limitation, response time, and a time rate of change of the measurement signal using the generated filter; an instrumentation amplifier; a scaler and/or a divider; and a bridge simulator or output interface circuit.

In one embodiment, a processor or processing circuit with memory is configured to receive the amplified measurement signal from the instrumentation amplifier, compensate the measurement signal for non-radiation errors, generate a filter based on the bandwidth limitation, response time, and the time rate of change of the measurement signal, attenuate an upset signal from the measurement signal using the generated filter and send the measurement signal to the scaler.

A method embodiment may include: a step for receiving a measurement signal from a sensor, a step for amplifying the measurement signal, a step for compensating the measurement signal for non-radiation errors, a step for generating a filter based on the bandwidth limitation, response time, and the time rate of change of the measurement signal, a step for attenuating an upset signal from the measurement signal using the generated filter, and a step for sending the measurement signal to a scaler.

A system embodiment may include: an upset event detector configured to determine if an upset event exists in a measurement signal; and a processor in communication with the upset event detector, where the processor may be configured to: compensate the measurement signal for the upset event if the upset event may be determined to exist by the upset event detector.

Additional system embodiments may include: a sensor configured to generate the measurement signal, where the processor may be in further communication with the sensor. In additional system embodiments, the generated measurement signal may be configured to measure at least one of: a pressure, a temperature, and a strain. In additional system embodiments, the sensor comprises at least one of: a silicon-on-oxide (SOI) sensor, a SOI strain gauge, a Resistance Temperature Detector (RTD) sensor, and a thin film sensor.

In additional system embodiments, the upset event may be a single-event upset. In additional system embodiments, the upset event may be a multiple upset event.

In additional system embodiments, the processor may be further configured to: receive the measurement signal from the sensor. In additional system embodiments, the processor may be further configured to: process the received measurement signal to remove errors. In additional system embodiments, the processor may be further configured to: amplify the processed measurement signal, where the compensated measurement signal may be the amplified measurement signal. In additional system embodiments, the processor may be further configured to: scale down the amplified measurement signal after the signal has been compensated. In additional system embodiments, the processor may be further configured to: output the scaled measurement signal.

In additional system embodiments, the processor comprises a passive compensation unit configured to: process the received measurement signal to remove errors. In additional system embodiments, the processor comprises an instrumentation amplifier configured to: amplify the processed measurement signal, where the compensated measurement signal may be the amplified measurement signal. In additional system embodiments, the processor comprises a scaler configured to: scale down the amplified measurement signal after the signal has been compensated.

Additional system embodiments may include: an output interface circuit in communication with the processor, where the output interface circuit may be configured to output the scaled measurement signal. In additional system embodiments, the output interface circuit may be configured to simulate an output of an electronic bridge.

Another system embodiment may include: a passive compensation unit configured to passively compensate a measurement signal to remove errors; an instrumentation amplifier configured to amplify the measurement signal received from the passive compensation unit; an upset event detector configured to determine if an upset event exists in the measurement signal; a scaler configured to scale down the amplified measurement signal received from the instrumentation amplifier; and a bridge simulator configured to output the measurement signal. Additional system embodiments may include: a sensor configured to generate the measurement signal.

A method embodiment may include: receiving a measurement signal from a sensor; amplifying the measurement signal; compensating the measurement signal for non-radiation errors; generating a filter based on one or more of: a bandwidth limitation, a response time, and a time rate of change of the measurement signal; attenuating an upset signal detected by an upset event detector from the measurement signal using the generated filter; and sending the measurement signal to a scaler via the active compensation unit.

In additional method embodiment, the filter comprises a bandwidth limited filtering with significantly lower frequency than a frequency of an upset event signal detected by the upset event detector.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a functional block diagram of an embodiment of a system for filtering upset events, according to one embodiment;

FIG. 2 depicts a circuit of an implementation of the system for filtering upset events of FIG. 1;

FIG. 3A depicts an active compensation unit adding an inverse upset signal to an amplified measurement signal;

FIG. 3B depicts an active compensation unit subtracting an upset signal from an amplified measurement signal;

FIGS. 4A-C depicts different types of outputs from an output interface circuit;

FIG. 5 is a schematic diagram of an alternate system for filtering upset events, according to one embodiment;

FIG. 6 is a flow-chart diagram for a method embodiment;

FIG. 7 is a high-level block diagram of the system, according to one embodiment;

FIG. 8 depicts a top-level functional block diagram of a computing device system;

FIG. 9 depicts a high-level block diagram and process of a computing system for implementing an embodiment of the system and process;

FIG. 10 depicts a block diagram and process of an exemplary system in which an embodiment may be implemented; and

FIG. 11 depicts a cloud computing environment for implementing an embodiment of the system and process disclosed herein.

### DETAILED DESCRIPTION

The following description is made for the purpose of illustrating the general principles of the embodiments discloses herein and is not meant to limit the concepts disclosed herein. Further, particular features described herein can be used in combination with other described features in each of the various possible combinations and permutations. Unless otherwise specifically defined herein, all terms are to be given their broadest possible interpretation including meanings implied from the description as well as meanings understood by those skilled in the art and/or as defined in dictionaries, treatises, etc.

The techniques introduced below may be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

In one embodiment, a system and method disclosed herein detect upset events such as radiation in the form of Ionizing particles, Gamma radiation, or other upset events, which may induce a signal corruption or error signal within electronics, such as those of a measuring system. These upsets may be fast responding events often in the Nano or microsecond time frame. A detector such as a radiation detector may be utilized to measure the event, and a compensation unit may be employed to generate a correction signal. In addition, a rate of change detector in the signal path may be used to determine a non-measurement signal in need of correction. This system can trigger an event such as a sample and hold to “ride out or smooth out” the upset, by holding the previous slow-moving signal until the upset is past. In some embodiments, the system may also determine the expected change of the signal over the upset time and fill in the expected signal.

An embodiment of a system disclosed herein allows for the filtering of upset events from measurement signals. Examples of such measurement signals include temperature change signals, pressure change signals, etc. Measurement signals may include an electrical signal from a pressure sensor device, an electrical signal from a temperature sensor device, etc. A Single Event Upset (SEU) such as neutron radiation, alpha radiation, gamma burst or Beta particle exposure may be a transient event. This SEU may induce short duration electrical transients on components such as transistors; integrated transistors; memory cells; combinational logic; analog circuits including comparators; operational amplifiers; and similar devices. Upset events may be a SEU or a multiple upset event. Embodiments disclosed herein utilize bandwidth limitation, the response time, and time rate of change of a measurement signal, in an implementation of an electronic circuit, to determine, manage and/or mitigate induced SEUs and/or multiple event upsets. In one example, an upset signal caused by ionizing radiation is a fast signal on the order of about a thousand times faster than a pressure change signal and about 10,000 times faster than a temperature change signal.

One embodiment of a system disclosed herein comprises an electronic circuit including a signal filter to attenuate an upset signal, maintaining the upset signal lower than a percentage of the full-scale signal, to reduce and/or eliminate upset signal effects on incoming measurement signals. In one implementation, the filter comprises an electrical signal filter configured to attenuate a fast upset signal due to radiation and keep the upset signal to less than about 0.1% of the full-scale signal, thereby reducing and/or eliminating the radiation transient effect on a measurement signal.

In one example, a pressure sensor or measurement device, such as a strain gauge, may be used to measure pressure in an environment, such as a physical media pressure, e.g., fluid pressure. A sensor, such as a pressure sensor measuring a physical parameter change, has a known or predictable time rate of change characteristic output measurement signal as a physical parameter. The physical parameter is the pressure signal for this example. The rate of change for any physical parameter for other types of sensor will also have this characteristic. For example, pressure will change at a typical rate of change with a time constant of about 1 ms, temperature is typically a slow event in terms of seconds. These sensors typically produce an electronic signal proportional to the measured parameter. The physical parameter has a limited bandwidth, or time constant, which cannot be exceeded by the physical media response. This is a characteristic for physical parameters found in spacecraft, airplanes, nuclear power plants, and other applications where charge affecting particles and radiation may cause an upset in the operation of embedded electronics operating using measurement signals.

A Wheatstone bridge may be used to measure physical parameters such as temperature, light, pressure, strain, etc. In one embodiment, a strain gauge Wheatstone bridge may be used as a typical transducer element that provides a conversion from pressure into an electrical measurement signal, which must be processed to be useable as an accurate measure of pressure, according to an embodiment disclosed herein.

Harsh operating environments may make it difficult not only to measure a parameter, e.g., pressure, temperature, but also to process the electrical measurement signals produced by the measurement devices. The difficulties in processing signals from measurement devices in these harsh environments include, for example, processing thermal compensation of inaccuracies. Strain gauge inaccuracies may result from mismatches in strain gauge resistors during fabrication. These mismatches may result in a zero pressure measurement offset error that varies with temperature. According to one embodiment, a compensating electronic circuit disclosed herein may be added to the application of measurement devices to compensate for these errors and increase the accuracy of the readings, i.e., measurement signals, from measurement devices.

Another example of measurement signal inaccuracy may be caused by the variation of strain in strain sensors, such as within the substrate that the strain resistors are deposited on. This substrate can be a material such as metal, ceramic, silicon, or other elastic deforming surface. This variation may be seen as an error in pressure measurement signal other than zero pressure. This may be considered a “span error” or the difference of full-scale pressure minus the zero reading. This span error may be temperature related. According to one embodiment, an electronic circuit disclosed herein may be added to the application of strain sensors to compensate said effect in signal processing of the measurement signal from the strain sensor.

Another example type of measurement signal inaccuracy or error may be due to the signal processing electronics itself. This type of error may be compensated by an electronic circuit according to one embodiment of the invention.

A method and system including an electronic circuit, to reduce such inaccuracies and errors, is described herein in exemplary embodiments. In one example method disclosed herein, the pressure media, e.g., fluid, may be fed through a connection such as a tube to a remotely mounted measuring device such as sensing transducer, and signal processing electronics, in a cooler surrounding environment. The remote mounting provides a cooler atmosphere, whereby high temperature media maintains the pressure, but is cooled by radiated emissions to the cooler surrounding atmosphere. The remote mount method provides measurements of hot media but operates the sensors within a cooler environment.

Another example method disclosed herein includes use of a high temperature strain gauge such as a Silicon On Insulator (SOI) high output transducer, e.g., 10 mv output/volt excitation at full scale pressure. Such strain gauges operate at a high temperature, and may be passively compensated, but do not offer idealized characteristics such as tight tolerance input impedance, tight tolerance output impedance, amplified voltage output, or selectable impedance ranges, e.g., 300 ohms, 1000 ohms, 5000 ohms industry standard ranges.

Another embodiment disclosed herein, includes utilizing a high temperature transducer such as the SOI strain gauge or a thin film high temperature strain gauge on a high temperature substrate. This transducer is coupled into a high temperature instrumentation amplifier which provides a voltage output.

In one embodiment, a method and system disclosed herein provides filtering of single-event upsets from measurement signals (measuring signals). An implementation of the system may be configured to operate in temperatures between about 200° C. to about 300° C. Other temperature ranges are possible and contemplated. In one example of the system disclosed herein according to one embodiment, the system comprises an electronic circuit that may include heat-resistant electronic components such as heat-resistant diodes, resistors, transistors, instrumentation amplifiers, capacitors, and substrates that can operate in temperatures between about 150° C. to about 300° C. Other operating temperature ranges are possible and contemplated. The example system may include high-temperature operating transducers such as a silicon-on-insulator (SOI) sensor, a resistance temperature detector (RTD), a thin film sensor, or the like. The heat resistance of the example system allows for measurements in close proximity of high temperature environments where such close proximity can aid in increased accuracy, faster response time, reduced physical size, and improved resistance to chemicals, vibration and shock.

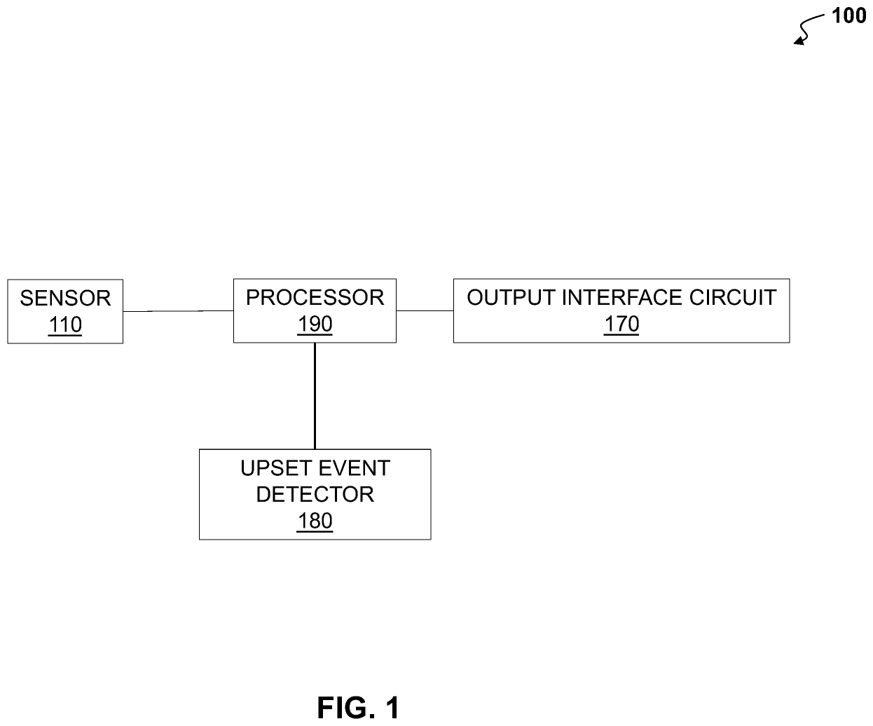

FIG. 1 depicts a functional block diagram of an embodiment of a system 100 including an electronic circuit for filtering the effect of upset events in a measurement signal. The electronic circuit in the system 100 may include a sensor 110 in communication with a processor 190. The processor 190 may be in communication with an upset event detector 180. The processor 190 may output a signal to an output interface circuit 170.

In one embodiment, the sensor 110 is configured to generate a measurement signal based on measuring a parameter, e.g., pressure, temperature, strain, etc. The upset event detector 180 is configured to determine or detect if an upset event exists that effects the measurement signal. The determined or detected upset event may be a single-event upset or a multiple upset event. The processor 190 is configured to process the generated measurement signal from the sensor 110, compensate for any upset events detected by the upset event detector 180, and output a modified measurement signal that more accurately represents the measured parameter.

In one embodiment, the processor 190 is configured to: receive the measurement signal from the sensor 110; process the received measurement signal including compensating for or reducing errors due to upset events as determined by the upset event detector 180; scale down the measurement signal after the signal has been compensated, and output the scaled compensated measurement signal.

In one example, the sensor 110 may include a high-temperature operating transducer such as a SOI sensor, a SOI strain gauge, a RTD, a thin film sensor or the like. In one embodiment, the sensor 110 may include a thermistor. In one embodiment, the sensor 110 may include a thermowell. In one embodiment, the sensor 110 may include thermocouples. In one embodiment, the sensor 110 may include a temperature sensor. In one embodiment, the sensor 110 may include a pressure sensor.

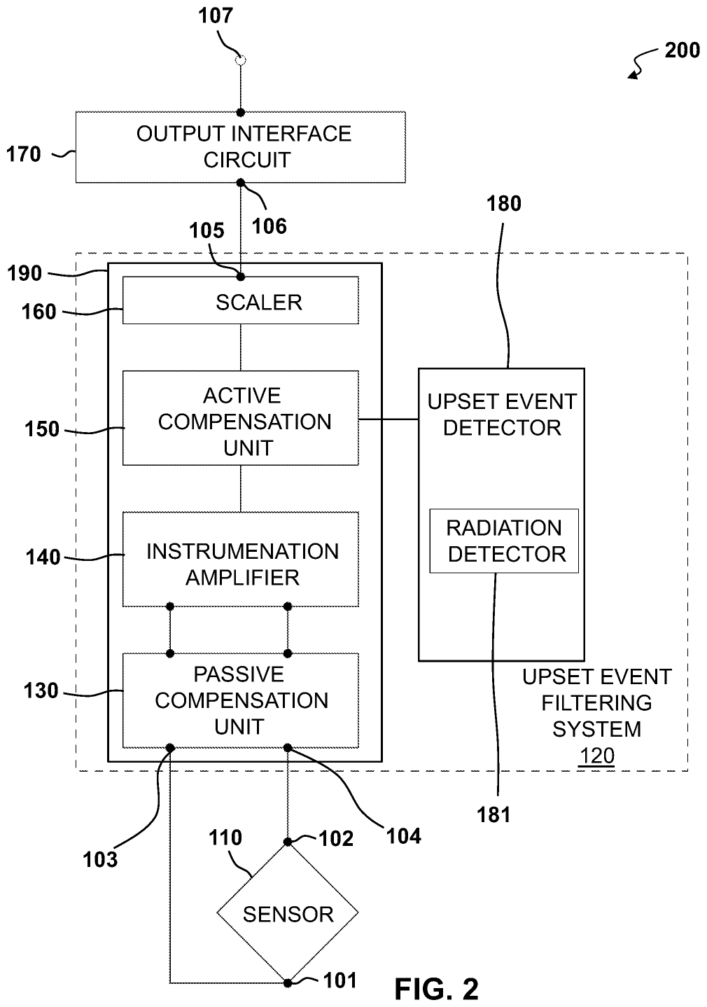

FIG. 2 depicts an example electronic circuit 200 as an implementation of the system 100 of FIG. 1 for filtering single-event upsets, disclosed herein. In one embodiment, the processor 190 may comprise signal processing electronics, configured to receive a measurement signal from the sensor 110. In some embodiments, the received measurement signal may be in the form of a differential output from the sensor 110. The processor 190 may include a passive compensation unit device 130, an instrumentation amplifier device 140, an active compensation unit device 150, and a scaler unit device 160.

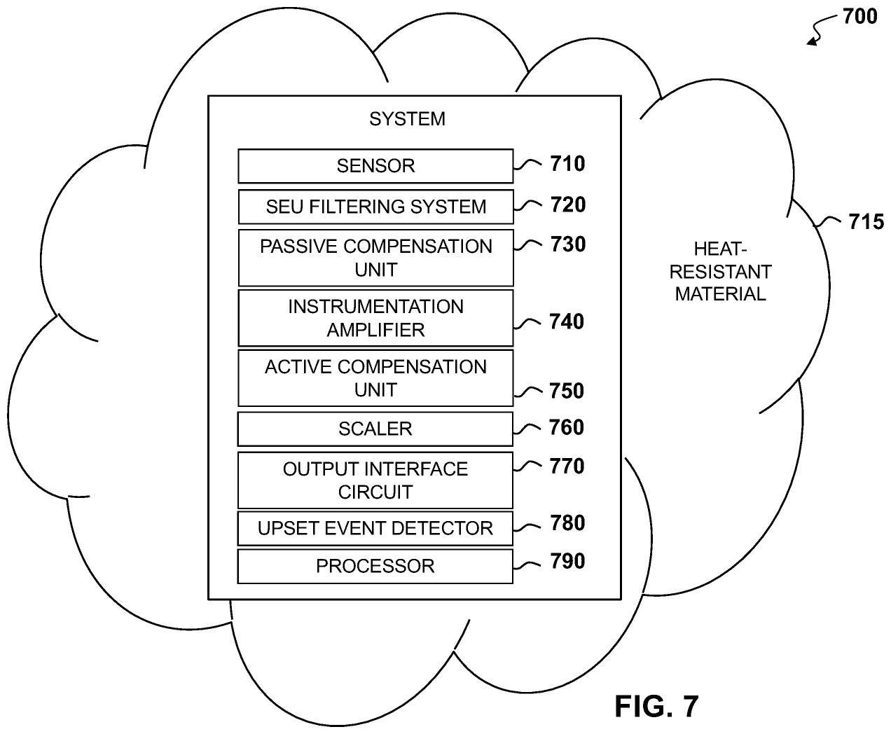

In one embodiment, processor 190 is configured to process the received measurement signal and remove errors, including: amplifying the measurement signal by the amplifier 140, actively compensating the amplified measurement signal by the active compensation unit 150 for upset events based on measurements of the upset event from an upset event detector 180, scaling down the amplified measurement signal by the scaler unit 160 after the signal has been compensated, and output the processed measurement signal to an output interface circuit 170. In some embodiments, the processor 190 may include a table look up, computational digital circuits, mixed analog/digital implementation, and/or computational analog electronic circuits. In one embodiment, the upset event detector 180 may generate measurements of an upset event as electrical detection signals. In one example, the upset event detector 180 may include a radiation detector 181 for detecting upset events caused by radiation such as ionizing particles and gamma radiation. In one embodiment, the upset event detector 180 may include a rate of change detector for detecting upset errors in measurement signals. In other embodiments, the upset event detector 180 may detect upset errors in non-measurement signals. If the upset event detector 180 determines that an upset error exists in a measurement signal, the processor 190 may sample and hold the non-measurement signal until the upset event has passed. The example circuit 200 can withstand high temperature and high radiation environments. In some embodiments, the circuit 200 may be fully encased in a heat-resistant material, including are metal, ceramic, cermet, and high-temperature plastics. In some embodiments, a portion of the circuit 200 may be encased in a heat-resistant material (715, FIG. 7). The circuit 200 includes a sensor 110, an upset event filtering system 120, and an output interface circuit 170. The sensor 110 may include a high-temperature operating transducer such as a SOI sensor, a SOI strain gauge, a RTD, a thin film sensor or the like. In some embodiments, the sensor 110 may include a thermistor. In some embodiments, the sensor 110 may include a thermowell. In some embodiments, the sensor 110 may include thermocouples. In some embodiments, the sensor 110 may be a temperature sensor. In some embodiments, the sensor 110 may be a pressure sensor.

In one embodiment, the circuit 200 functions as an upset event filtering system that receive a measurement signal at inputs 103 and 104 from outputs 101 and 102 of the sensor 110. In some embodiments, the received measurement signal may be in the form of a differential output from the sensor 110. The circuit 200 may include a passive compensation unit 130 that in one embodiment passively compensates the measurement signal to remove errors. In some embodiments, the passive compensation unit 130 may include resistors configured to passively compensate the measurement signal. Electronic circuits used herein are designed to have a correction factor inversely proportional to an error as seen in an imperfect sense element. By adjusting the magnitude of this inverse relationship, the error term, adjusted by passive circuit elements which themselves are selected, dialed or trimmed, additively or multiplicatively cancel the error. This process is called compensation.

The instrumentation amplifier 140 may receive the measurement signal from the passive compensation unit 130 and amplify the measurement signal for the active compensation unit 150. In some embodiments, the instrumentation amplifier 140 may receive the measurement signal in the form of a differential output. In some embodiments, the instrumentation amplifier 140 may be a high-temperature operating instrumentation amplifier.

In some embodiments, the processor 190 may compensate for the upset event by including a specific filter for each upset signal based on the bandwidth limitation, response time, the time rate of change of the measurement signal, and measurements taken by the upset event detector 180. In other embodiment, the processor 190 may compensate for multiple event upset signals in the measurement signal

In some embodiments, the circuit 200 may not include a passive compensation unit 130. In some embodiments, the passive compensation unit 130 may be subsisted by a processor configured to filter the measurement signal through active table look up, polynomial calculation, component characteristic matching, and the like.

In one embodiment, the active compensation unit 150 may compensate the amplified measurement signal for non-upset errors such as span errors, offset errors, non-linearity errors, temperature dependence errors, and the like. The active compensation unit 150 may further compensate the amplified measurement signal for single-event upsets based on measurements of the upset event from the upset event detector 180. The upset event detector 180 may include a radiation detector 181 for detecting upset events caused by radiation such as ionizing particles and gamma radiation. In some embodiments, the active compensation unit 150 may include a microprocessor, a table look up, mixed analog/digital implementation, and/or computational analog circuits.

In one embodiment, the active compensation unit 150 may compensate for the upset event by utilizing a specific filter for each upset signal based on the bandwidth limitation, response time, the time rate of change of the measurement signal, and measurements taken by the upset event detector 180. For example, the active compensation unit 150 may utilize a bandwidth limited filter with significantly lower frequency than the measured upset-event.

In some embodiments, the active compensation unit 150 may generate a specific filter for each upset signal for a limited period of time. For example, a filter may be generated for a set period and resume without the generated filter after the set period.

In other embodiments, the active compensation unit 150 may detect the upset signal perturbation and add an opposite amplitude signal (Analog). In other embodiments the active compensation unit 150 may detect an upset signal perturbation and subtracting the opposite amplitude signal (Digital). In yet another embodiment the compensation unit 150 may sample and hold an upset signal perturbation that rides over the perturbation.

The upset event signal due to an ionizing radiation may be fast in the order of microseconds. In some embodiments, the measurement signal received from the sensor 110 may be about 1000 times slower than the detected upset. A rate of change detector, which may be included in the active compensation unit 150 in some embodiments, may be used as the detector 180 to detect the transient.

In one embodiment, depending on the nature of the transient based on a transient bandwidth or time width, the circuit 200 may include one or more filters with different low pass characteristics or a sample and hold. The threshold may be based on rate of change and amplitude. A combined signal upset based on the transient upset time-width and amplitude may be used to determine the attenuation characteristics of the filter to achieve an upset level, such as less than about 0.5%. For example, about 0.5 for an error band of about 1% where the error of the signal in normal situations is calibrated to be about 0.5% or less.

In one embodiment, the upset event detector 180 may include a rate of change detector for detecting upset errors in measurement signals. In one embodiment, if a sensor 110 is providing temperature measurements, and a temperature measurement rate-of-change is detected to be higher than the temperature sensor 110 is capable of, the upset event detector 180 may provide a signal to the active compensation unit 150 indicating that an upset error exists in a measurement signal. Subsequently, the active compensation unit 150 may sample and hold the non-measurement signal until the upset event has passed. In another embodiment, the upset event detector 180 may detect upset errors in non-measurement signals.

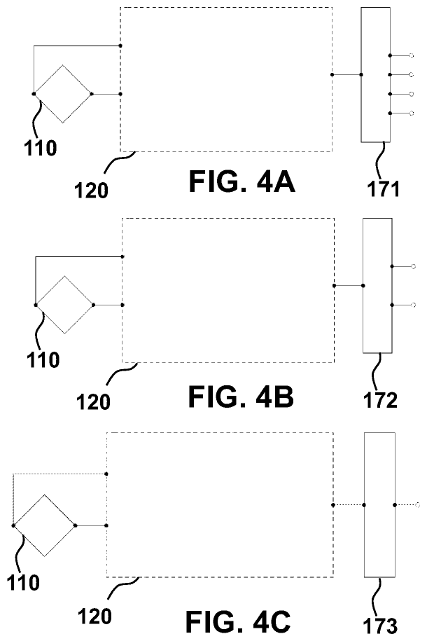

The scaler unit 160 may scale down the amplified measurement signal after the signal has been compensated by the active compensation unit 150. In one embodiment, the scaler 160 may attenuate the amplified measurement signal as needed by the application. The measurement signal may then leave the circuit 200 through output 105 and enter the output interface circuit 170 through input 106. In some embodiments, as described in more detailed in relation to FIGS. 4A-4C, the output interface circuit 170 is configurable and in one example may comprise circuitry that simulates output of an electronic bridge, such as a Wheatstone bridge output. The compensated measurement signal then leaves the output interface circuit 170 through output 107 as a measurement of a parameter such as pressure, temperature or some other useful parameter. This may be used as a measurement device for an outside system.

In some embodiments, the processor 190 may be operatively coupled to the output interface circuit 170, the sensor 110, and the upset event detector 180. The processor 190 may allow a user to customize the output interface circuit 170 and the sensor 110 through a user interface. For example, the sensor 110 may be configured by the processor 190 using parameters such as input impedance, output impedance, resistance values, offset, gains, and common mode bridge voltage. In another example, the processor 190 may be a microprocessor configured for the switchable selection of discrete values. In one embodiment, the processor 190 may compensate for the upset event by adjusting the parameters to induce a corresponding voltage change.

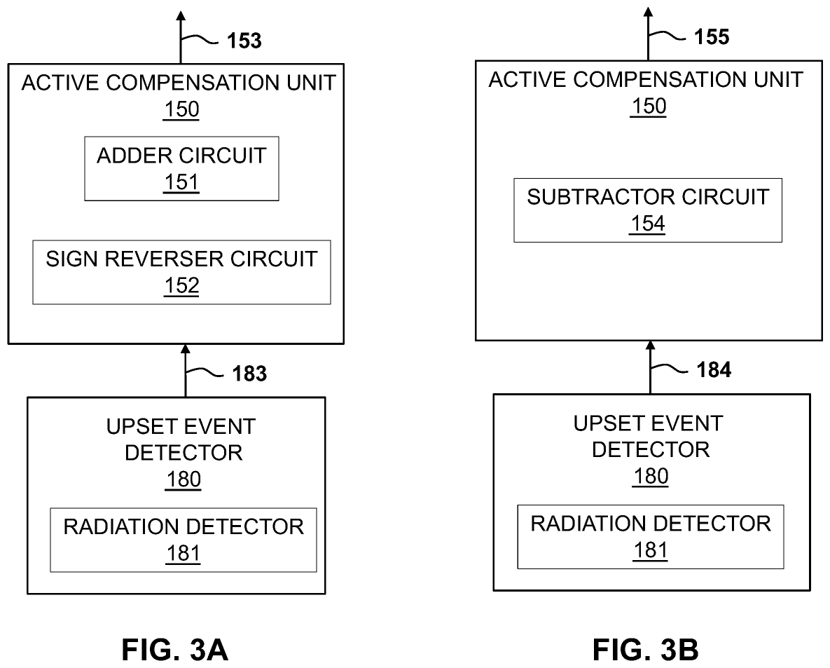

Referring now to FIGS. 3A-B, in one embodiment, the active compensation unit 150 may compensate for an upset event by adding an inverse upset signal or subtracting an upset signal from an amplified measurement signal.

FIG. 3A depicts the active compensation unit 150 adding an inverse upset signal to the amplified measurement signal. The active compensation unit 150 may include an adder circuit 151 and a sign-reverser circuit 152. The upset event detector 180 may generate an upset signal based on the measurements obtained from the radiation detector 181. The upset event detector 180 may then send the generated upset signal 183 to the active compensation unit 150. The sign reverser circuit 152 may then reverse the sign on the upset signal, allowing the adder circuit 151 to add the inverse upset signal to an amplified measurement signal to generate a compensated measurement signal 153 as output of the active compensation unit 150.

FIG. 3B depicts the active compensation unit 150 subtracting an upset signal from the amplified measurement signal. The active compensation unit 150 may include a subtractor circuit 154. The upset event detector 180 may generate an upset signal based on the measurements obtained from the radiation detector 181. The upset event detector 180 may then send the generated upset signal 184 to the active compensation unit 150. The subtractor circuit 154 may then subtract the generated upset signal 184 from the amplified measurement signal to generate a compensated measurement signal 155 as output of the active compensation unit 150.

Referring to FIG. 2, an embodiment of the circuit 200 includes an upset event filtering system 120 comprising the processor 190 and the detector 180, wherein the input to the filtering system 120 is generated by the sensor 110, and the output of the filtering system 120 is fed into the output interface circuit 170.

FIGS. 4A-C show different implementations of the output interface circuit 170, providing different types of outputs, according to embodiments disclosed herein. The processor 190 may configure the output interface circuit 170 to generate different types of outputs depending on application of the circuit (200, FIG. 2). In one embodiment, the output interface circuit is configured as a circuit 171 that provides four outputs simulating the outputs of a Wheatstone bridge. In one embodiment, the output interface circuit is configured as a circuit 172 that provides differential outputs with low impedance. In another embodiment, the output interface circuit is configured as a circuit 173 that provides outputs as a single ended voltage output.

In some embodiments, the processor 190 may configure the output interface circuit 170 with a ratiometric output proportional to the excitation voltage used for the sensor 110. In some embodiments, the processor 190 may be included in the active compensation unit. In some embodiments, the processor 190 may have addressable memory. In some embodiments, the processor 190 may direct the sensor 110 to send a measurement signal to the upset event filtering system 120. In some embodiments, the processor 190 may direct an excitation voltage from a voltage regulator to the sensor 110.

In some embodiments, the processor 190 may be an analog circuit, a state machine, or a microprocessor. In some embodiments, the processor 190 can send a correction to any part of the circuit that is additive or subtractive. The correction may be sent to the sensor 110 itself, where a sensor excitation may produce a multiplicative effect on the sensor output. This may multiply both the sensor uncompensated zero error and full scale error, both of which may be independent variables. The result may be a new error introduced. In some embodiments, it may be preferable to send an additive section of the signal path.

In one embodiment, the processor (190, FIG. 2) may be configured to execute a predicative algorithm to compensate for the single-event upset. For example, the processor (190, FIG. 2) may be configured to execute a convolution algorithm using knowledge based correction.

In another embodiment, the processor (190, FIG. 2) may be configured to modulate the sensor 110 to compensate for the single-event upset. For example, the processor (190, FIG. 2) may modulate the sensor 110 to act in a multiplication effect based on an upset signal generated by the upset event detector (180, FIG. 2).

In another embodiment, the processor (190, FIG. 2) may be configured to determine the expected change of signal while the measurement signal is being sampled and held. Once the expected change of signal is determined, the processor (190, FIG. 2) may then fill in the expected signal.

In some embodiments, the processor (190, FIG. 2) may be configured to initiate a systematic correction based on the measurements obtained from the upset event detector (180, FIG. 2). For example, the processor (190, FIG. 2) may configure the initial calibrations to compensate for the detected single-event upset.

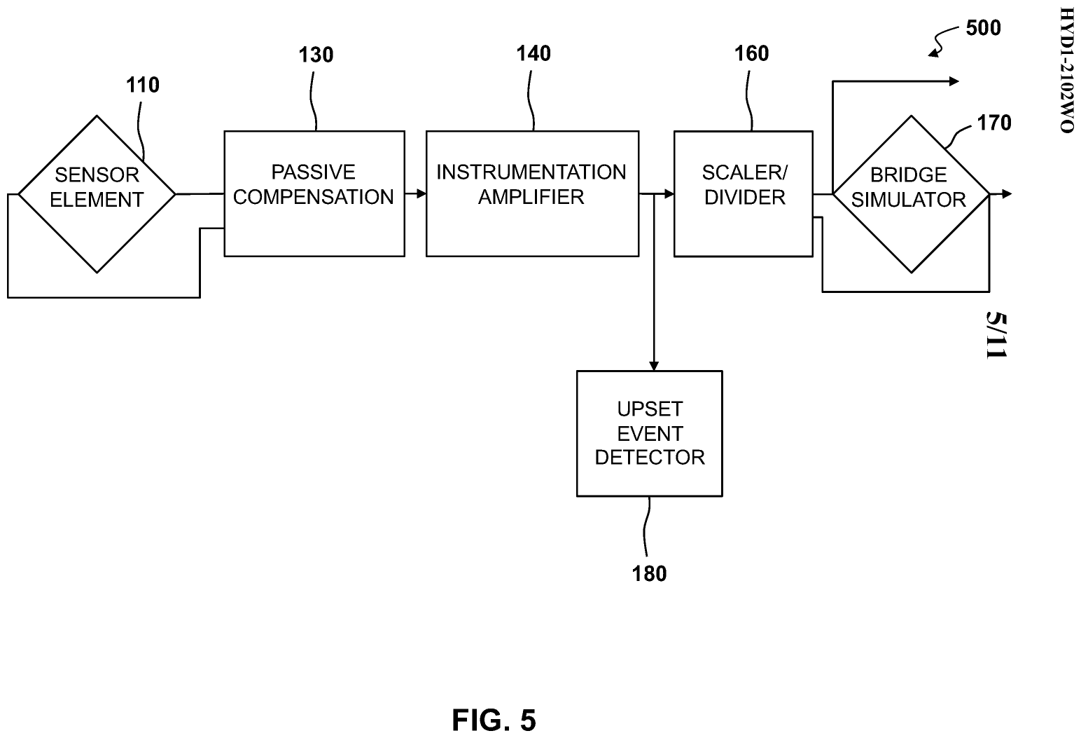

FIG. 5 shows a functional block diagram of another system 500, according to one embodiment, wherein the system 500 comprises a circuit including a sensor 110, a passive compensation unit 130, an instrumentation amplifier 140, a scaler 160, an output interface circuit 170, and an upset event detector 180. In some embodiments, the scaler 160 may comprise a scaler or divider. In some embodiments, the output interface circuit 170 may be an electronic bridge simulator such as described herein. The bridge simulator may be a scaler in some embodiments. The system 500 provides an alternate output format than the general form of the system 200 of FIG. 2. The system 500 allows simulation of a sense element as an output of the bridge simulator 170. This provides a means of segregating each portion of the sensor 110 to allow optimization of the characteristics of each portion independent of all others such as sensor characteristics, calibration/compensation portion, the amplifier portion and the output simulation.

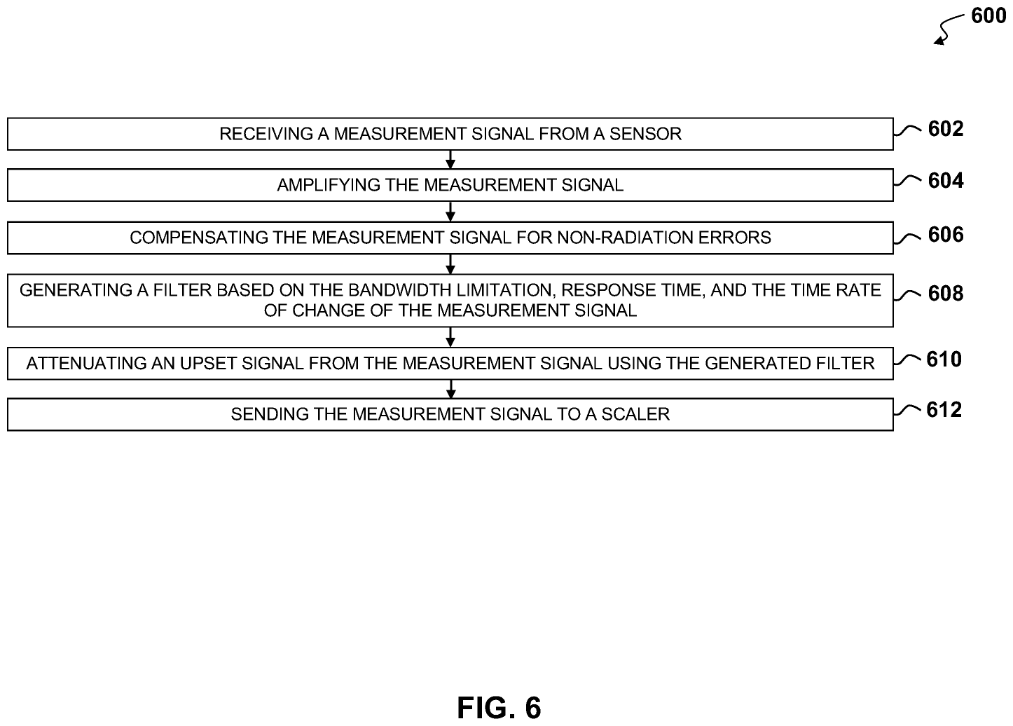

FIG. 6 shows a flowchart depicting a method 600 for attenuating or reducing upset signals from a measurement signal. In one embodiment, the method 600 may initiate with receiving a measurement signal from a sensor (step 602). The method 600 may then include amplifying the measurement signal (step 604). The method 600 may then include compensating the measurement signal for error events (step 606). Error events may include a single-event upset and/or multiple upset events. The method 600 may then include generating a filter based on the bandwidth limitation, response time, and the time rate of change of the measurement signal (step 608). In one embodiment, generating a filter comprises configuring a filtering process. In another embodiment, the filter may comprise a filtering process configured by the processor 190. In other embodiments, the filter may be a process configured by the active compensation unit 150. The filter may comprise a bandwidth limited filtering with significantly lower frequency than a frequency of an upset event signal detected by the upset event detector 180. The method 600 may then include attenuating an upset signal from the measurement signal using the generated filter (step 610). The method 600 may then include sending the measurement signal to a scaler to be scaled (step 612), such as by the scaler (160, FIG. 2).

FIG. 7 shows a high-level functional block diagram of a system 700, according to one embodiment. The system 700 may include a sensor 710, a SEU filtering system 720, a passive compensation unit 730, an instrumentation amplifier 740, an active compensation unit 750, a scaler 760, an output interface circuit 770, an upset event detector 780, and a processor 790. In some embodiments, a portion of the system 700 may be encased in a heat-resistant material 715. In some embodiments, the system 700 may include computational digital circuits, mixed analog/digital implementation, and/or computational analog electronic circuits. In one embodiment, the detection signal, either rate of change, radiation, or other, can be used to institute a system correction. In the case where memory is used to hold the initial calibration, a standard error correction or a programmable sequence operation (program or algorithm) may be utilized. This correction can be used to detect and correct the memory circuits. Methods to correct the memory may be cyclic redundancy correction codes, memory parity, and/or shadow or redundant memory. This also may add to these standard corrections the capability through characterization of the upset (e.g., ionizing radiation), the likely location of the upset event, and a likely correction.

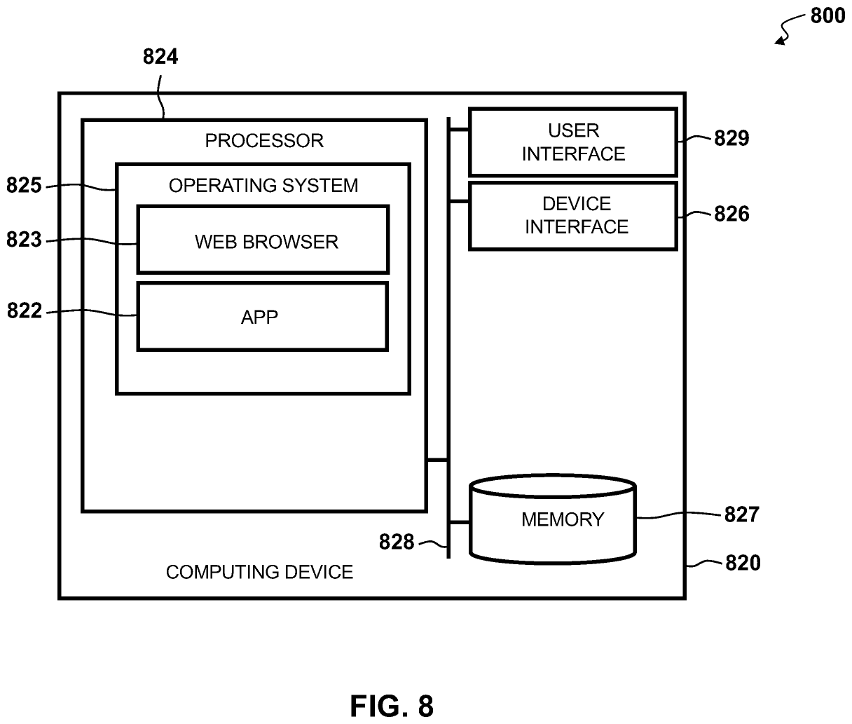

With respect to FIG. 8, an example of a top-level functional block diagram of a computing device system 800 is illustrated. The system 800 is shown as a computing device 820 comprising a processor 824, such as a central processing unit (CPU), addressable memory 827, an external device interface 826, e.g., an optional universal serial bus port and related processing, and/or an Ethernet port and related processing, and an optional user interface 829, e.g., an array of status lights and one or more toggle switches, and/or a display, and/or a keyboard and/or a pointer-mouse system and/or a touch screen. Optionally, the addressable memory may include any type of computer-readable media that can store data accessible by the computing device 820, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network, such as a LAN, WAN, or the Internet. These elements may be in communication with one another via a data bus 828.

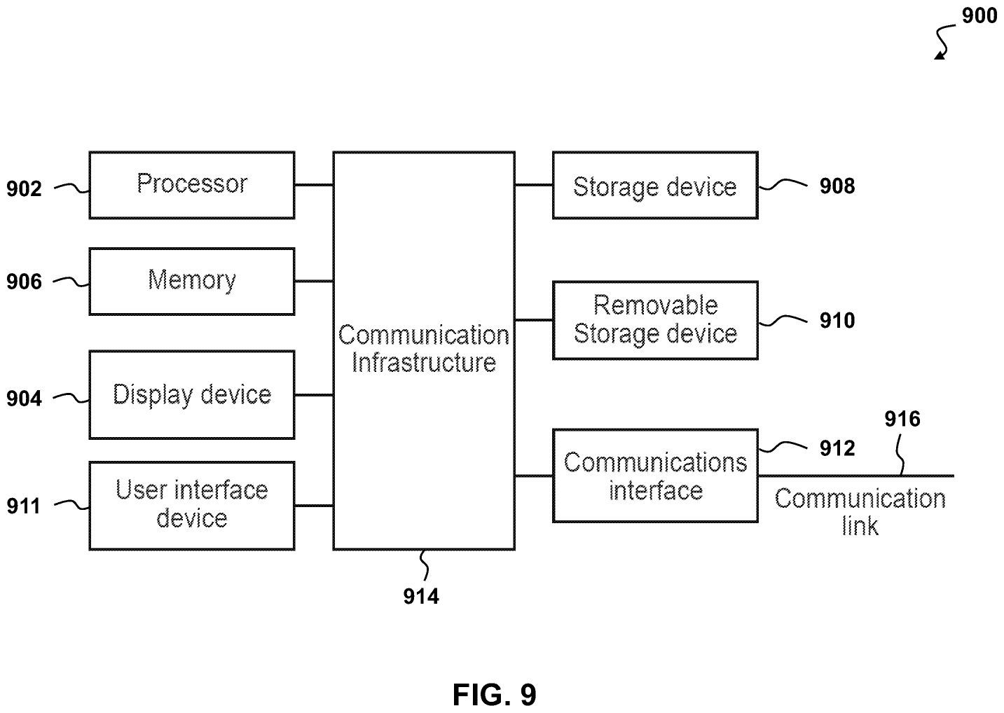

FIG. 9 is a high-level block diagram 900 showing a computing system comprising a computer system useful for implementing an embodiment of the system and process, disclosed herein. Embodiments of the system may be implemented in different computing environments. The computer system includes one or more processors 902, and can further include an electronic display device 904 (e.g., for displaying graphics, text, and other data), a main memory 906 (e.g., random access memory (RAM)), storage device 908, a removable storage device 910 (e.g., removable storage drive, a removable memory module, a magnetic tape drive, an optical disk drive, a computer readable medium having stored therein computer software and/or data), user interface device 911 (e.g., keyboard, touch screen, keypad, pointing device), and a communication interface 912 (e.g., modem, a network interface (such as an Ethernet card), a communications port, or a PCMCIA slot and card). The communication interface 912 allows software and data to be transferred between the computer system and external devices. The system further includes a communications infrastructure 914 (e.g., a communications bus, cross-over bar, or network) to which the aforementioned devices/modules are connected as shown.

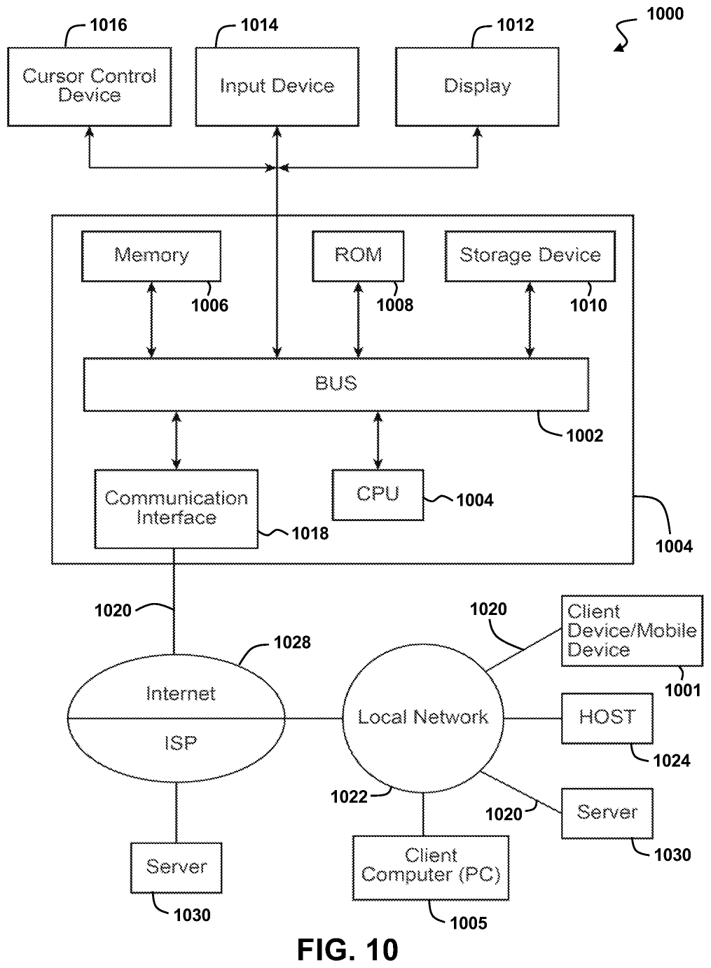

FIG. 10 shows a block diagram of an example system 1000 in which an embodiment may be implemented. The system 1000 includes one or more client devices 1001 such as consumer electronics devices, connected to one or more server computing systems 1030. A server 1030 includes a bus 1002 or other communication mechanism for communicating information, and a processor (CPU) 1004 coupled with the bus 1002 for processing information. The server 1030 also includes a main memory 1006, such as a random access memory (RAM) or other dynamic storage device, coupled to the bus 1002 for storing information and instructions to be executed by the processor 1004. The main memory 1006 also may be used for storing temporary variables or other intermediate information during execution or instructions to be executed by the processor 1004. The server computer system 1030 further includes a read only memory (ROM) 1008 or other static storage device coupled to the bus 1002 for storing static information and instructions for the processor 1004. A storage device 1010, such as a magnetic disk or optical disk, is provided and coupled to the bus 1002 for storing information and instructions. The bus 1002 may contain, for example, thirty-two address lines for addressing video memory or main memory 1006. The bus 1002 can also include, for example, a 32-bit data bus for transferring data between and among the components, such as the CPU 1004, the main memory 1006, video memory and the storage 1010. Alternatively, multiplex data/address lines may be used instead of separate data and address lines.

The server 1030 may be coupled via the bus 1002 to a display 1012 for displaying information to a computer user. An input device 1014, including alphanumeric and other keys, is coupled to the bus 1002 for communicating information and command selections to the processor 1004. Another type or user input device comprises cursor control 1016, such as a mouse, a trackball, or cursor direction keys for communicating direction information and command selections to the processor 1004 and for controlling cursor movement on the display 1012.

According to one embodiment, the functions are performed by the processor 1004 executing one or more sequences of one or more instructions contained in the main memory 1006. Such instructions may be read into the main memory 1006 from another computer-readable medium, such as the storage device 1010. Execution of the sequences of instructions contained in the main memory 1006 causes the processor 1004 to perform the process steps described herein. One or more processors in a multi-processing arrangement may also be employed to execute the sequences of instructions contained in the main memory 1006. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 1004 for execution. Such a medium may take many forms, including but not limited to, non-volatile media, volatile media, and transmission media. Non-volatile media includes, for example, optical or magnetic disks, such as the storage device 1010. Volatile media includes dynamic memory, such as the main memory 1006. Transmission media includes coaxial cables, copper wire and fiber optics, including the wires that comprise the bus 1002. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 1004 for execution. For example, the instructions may initially be carried on a magnetic disk of a remote computer. The remote computer can load the instructions into its dynamic memory and send the instructions over a telephone line using a modem. A modem local to the server 1030 can receive the data on the telephone line and use an infrared transmitter to convert the data to an infrared signal. An infrared detector coupled to the bus 1002 can receive the data carried in the infrared signal and place the data on the bus 1002. The bus 1002 carries the data to the main memory 1006, from which the processor 1004 retrieves and executes the instructions. The instructions received from the main memory 1006 may optionally be stored on the storage device 1010 either before or after execution by the processor 1004.

The server 1030 also includes a communication interface 1018 coupled to the bus 1002. The communication interface 1018 provides a two-way data communication coupling to a network link 1020 that is connected to the world wide packet data communication network now commonly referred to as the Internet 1028. The Internet 1028 uses electrical, electromagnetic or optical signals that carry digital data streams. The signals through the various networks and the signals on the network link 1020 and through the communication interface 1018, which carry the digital data to and from the server 1030, are exemplary forms or carrier waves transporting the information.

In another embodiment of the server 1030, interface 1018 is connected to a network 1022 via a communication link 1020. For example, the communication interface 1018 may be an integrated services digital network (ISDN) card or a modem to provide a data communication connection to a corresponding type of telephone line, which can comprise part of the network link 1020. As another example, the communication interface 1018 may be a local area network (LAN) card to provide a data communication connection to a compatible LAN. Wireless links may also be implemented. In any such implementation, the communication interface 1018 sends and receives electrical electromagnetic or optical signals that carry digital data streams representing various types of information.

The network link 1020 typically provides data communication through one or more networks to other data devices. For example, the network link 1020 may provide a connection through the local network 1022 to a host computer 1024 or to data equipment operated by an Internet Service Provider (ISP). The ISP in turn provides data communication services through the Internet 1028. The local network 1022 and the Internet 1028 both use electrical, electromagnetic or optical signals that carry digital data streams. The signals through the various networks and the signals on the network link 1020 and through the communication interface 1018, which carry the digital data to and from the server 1030, are exemplary forms or carrier waves transporting the information.

The server 1030 can send/receive messages and data, including e-mail, program code, through the network, the network link 1020 and the communication interface 1018. Further, the communication interface 1018 can comprise a USB/Tuner and the network link 1020 may be an antenna or cable for connecting the server 1030 to a cable provider, satellite provider or other terrestrial transmission system for receiving messages, data and program code from another source.

The example versions of the embodiments described herein may be implemented as logical operations in a distributed processing system such as the system 1000 including the servers 1030. The logical operations of the embodiments may be implemented as a sequence of steps executing in the server 1030, and as interconnected machine modules within the system 1000. The implementation is a matter of choice and can depend on performance of the system 1000 implementing the embodiments. As such, the logical operations constituting said example versions of the embodiments are referred to for e.g., as operations, steps or modules.

Similar to a server 1030 described above, a client device 1001 can include a processor, memory, storage device, display, input device and communication interface (e.g., e-mail interface) for connecting the client device to the Internet 1028, the ISP, or LAN 1022, for communication with the servers 1030.

The system 1000 can further include computers (e.g., personal computers, computing nodes) 1005 operating in the same manner as client devices 1001, where a user can utilize one or more computers 1005 to manage data in the server 1030.

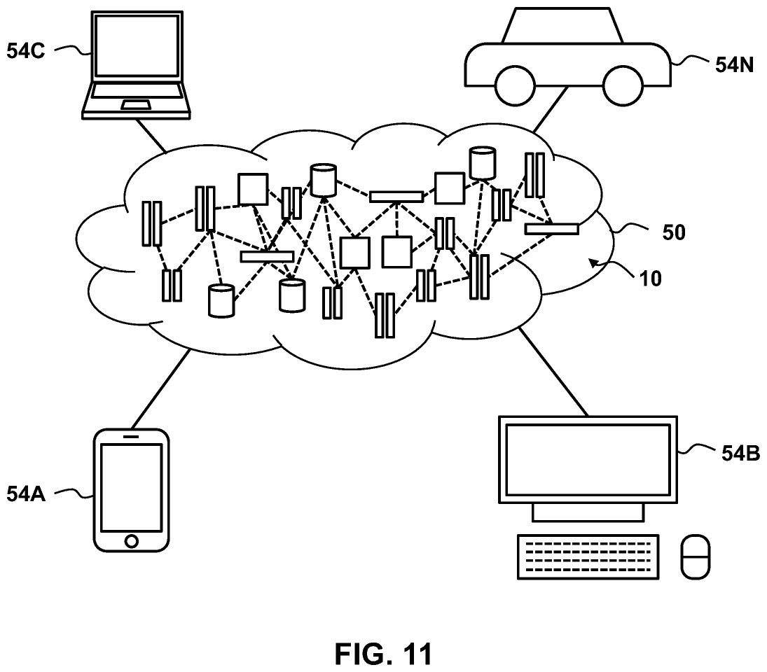

Referring now to FIG. 11, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 11 are intended to be illustrative only and that computing nodes 10 and cloud computing environment 50 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

1. A system comprising:
an upset event detector configured to determine if an upset event exists in a measurement signal; and
a processor in communication with the upset event detector, wherein the processor is configured to:
compensate the measurement signal for the upset event if the upset event is determined to exist by the upset event detector.

2. The system of claim 1, wherein the upset event detector is configured to determine if the upset event exists in the measurement signal based on a pre-determined threshold.

3. The system of claim 1, wherein the processor is further configured to compensate the measurement signal for the upset event using an adaptive filtering algorithm.

4. The system of claim 1, further comprising:
a sensor configured to generate the measurement signal, wherein the processor is in further communication with the sensor, wherein the generated measurement signal is configured to measure at least one of: a pressure, a temperature, and a strain, and wherein the sensor comprises at least one of: a silicon-on-oxide (SOI) sensor, a SOI strain gauge, a Resistance Temperature Detector (RTD) sensor, and a thin film sensor.

5. The system of claim 1, wherein the upset event is a single-event upset.

6. The system of claim 1, wherein the upset event is a multiple upset event.

7. The system of claim 4, wherein the processor is further configured to:
receive the measurement signal from the sensor;
process the received measurement signal to remove errors;
amplify the processed measurement signal, wherein the compensated measurement signal is the amplified measurement signal;
scale down the amplified measurement signal after the signal has been compensated; and
output the scaled measurement signal.

8. The system of claim 1, wherein the processor comprises a passive compensation unit configured to:
process the received measurement signal to remove errors.

9. The system of claim 8, wherein the processor is further configured to compensate the measurement signal for the upset event using the passive compensation unit.

10. The system of claim 8, wherein the processor comprises an instrumentation amplifier configured to:
amplify the processed measurement signal, wherein the compensated measurement signal is the amplified measurement signal;
wherein the processor further comprises a scaler configured to:
scale down the amplified measurement signal after the signal has been compensated.

11. The system of claim 10, further comprising:
an output interface circuit in communication with the processor, wherein the output interface circuit is configured to output the scaled measurement signal, wherein the output interface circuit is configured to simulate an output of an electronic bridge.

12. A system comprising:
a passive compensation unit configured to passively compensate a measurement signal to remove errors;
an instrumentation amplifier configured to amplify the measurement signal received from the passive compensation unit;
an upset event detector configured to determine if an upset event exists in the measurement signal;
a scaler configured to scale down the amplified measurement signal received from the instrumentation amplifier; and
a bridge simulator configured to output the measurement signal.

13. The system of claim 12, wherein the upset event detector is configured to determine if the upset event exists in the measurement signal based on a pre-determined threshold.

14. The system of claim 12, wherein the processor is further configured to compensate the measurement signal for the upset event using an adaptive filtering algorithm.

15. The system of claim 12, wherein the processor is further configured to compensate the measurement signal for the upset event using the passive compensation unit.

16. The system of claim 12, further comprising:
a sensor configured to generate the measurement signal.

17. A method comprising:
receiving a measurement signal from a sensor;
amplifying the measurement signal;
compensating the measurement signal for non-radiation errors;
generating a filter based on one or more of: a bandwidth limitation, a response time, and a time rate of change of the measurement signal;
attenuating an upset signal detected by an upset event detector from the measurement signal using the generated filter; and
sending the measurement signal to a scaler via the active compensation unit.

18. The method of claim 17, wherein the filter comprises a bandwidth limited filtering with significantly lower frequency than a frequency of an upset event signal detected by the upset event detector.

19. The method of claim 17, wherein the generated filter is based on a pre-determined threshold.

20. The system of claim 17, wherein the generated filet is based on an adaptive filtering algorithm.
